(19) United States
(12) Patent Application Publication
(10) Pub. No.: US 2024/0133226 A1
(43) Pub. Date: Apr. 25, 2024

(54) METHOD FOR OPERATING A DOOR ACTUATOR

(71) Applicant: dormakaba Deutschland GmbH, Ennepetal (DE)

(72) Inventors: Patrick Winkelmann, Ennepetal (DE); Alexey Kurkov, Ennepetal (DE); Dennis Meiering, Ennepetal (DE); Jonas Kirschner, Ennepetal (DE)

(21) Appl. No.: 18/365,010

(22) Filed: Aug. 2, 2023

(30) Foreign Application Priority Data
Aug. 11, 2022 (EP) 22190234.9

(51) Int. Cl. E05F 15/73

(52) U.S. Cl. CPC E05F 15/73; E05Y 2400/44; E05Y 2900/132

(57) ABSTRACT

A method for operating a door actuator of a door system, with at least one movable door leaf and a control device to control a drive of the door leaf, and with a sensor unit with which data of at least one object is recorded in a detection region in front of the door system and at least one item of information about the object is transmitted to the control device. The method includes at least the following steps in the order listed: a) recording object data of the object, b) processing the recorded object data, c) evaluating the processed object data, d) dividing the detection region into first and second partial regions, e) identifying a desire to enter of the object depending on the partial region in which the object data was recorded, and f) opening the door leaf only in the case of an identified desire to enter.

### CROSS-REFERENCE TO RELATED APPLICATIONS

This application claims the benefit of European patent application EP22190234.9 filed 12 Aug. 2022, the disclosure of which is incorporated herein by reference in its entirety.

### TECHNICAL FIELD

The disclosure relates to a method for operating a door actuator of a door system according to claim 1, in particular with at least one movable door leaf and with a control device which is designed to control a drive of the door leaf, and with a sensor unit with which data of at least one object is recorded in a detection region in front of the door system and at least one item of information about the object is transmitted to the control device. The disclosure is also aimed at a door actuator of a door system having a control device for carrying out the method as well as a software program product for implementation in the control device.

### BACKGROUND

EP 3 613 933 A1 discloses a method for operating an automatic door system which has a door actuator connected to a door leaf. It is indicated here that radar movement detectors are used to actuate the door movement for automatic sliding doors. For swing leaf doors, radar sensors are not common for detecting monitored regions if the sensors ultimately detect people and transmit corresponding data to a control unit to control the door system.

A method for operating an automatic door system is also known from DE 196 13 178 A1 and the door system has a door leaf which can be actuated via a door actuator. Furthermore, sensor units are proposed which cooperate with a control unit and the control unit can be actuated using sensor data such that the door system is optimally operated. Optimum operation of the door system is in particular seen as the opening behavior of the door system adapting to the passage frequency of the passing people. Thus, if a greater number of people pass the door system, the opening behavior should be designed differently to if only a single person passes the door system. Additionally, weather conditions, the time of day, the day of the week and, for example, also a temperature difference between the inside and outside of a building should also be taken into consideration.

In this case, an ideal condition is considered a door leaf only opening if a person actually wishes to pass the door system. In this respect, unnecessary opening operations are to be avoided. In particular in the case of so-called cross traffic, in which people approach the door system with a lateral movement direction running at least roughly parallel to the wall in which the door system is installed.

### SUMMARY

The disclosure further improves a method for operating a door system as well as to provide such a door system with which the method according to the disclosure can be carried out. The improvement should in particular be to provide an improved actuation of the door leaves of the door system even in the case of people approaching transversely to the door system. This should achieve an improved detection of the desire to enter of a person approaching transversely.

This is achieved by proceeding from a method according to claim 1, proceeding from a door actuator according to claim 14 and proceeding from a computer program product according to claim 15 in connection with each of the characterizing features. Advantageous further developments of the disclosure are indicated in the dependent claims.

The method provides at least the following steps to achieve the advantage, in particular in the order listed:
a) recording object data of the object, in particular of an object approaching the door system,
b) processing the recorded object data,
c) evaluating the processed object data,
d) dividing the detection region into a first partial region and into a second partial region,
e) identifying a desire to enter of the object depending on the partial region in which the object data was recorded and
f) opening the door leaf only in the case of an identified desire to enter.

The disclosure is a division of the detection region into a first partial region and into at least one second partial region, with the division also being able to comprise further partial regions and thus more than two partial regions.

Furthermore, the listing of the steps of the method is not exhaustive and intermediate steps as well as further upstream and downstream steps can be provided, in particular for the extended execution and improvement of the method.

The method is preferably used in a door system comprising at least one door leaf. As is known per se, door systems with only one door leaf have a hinge side and a closing side, and according to the disclosure, the detection region can be subdivided such that the first partial region of the detection region is on the hinge side and the second partial region of the detection region is on the closing side.

In other words, the object data is evaluated differently in step c, depending on the partial region in which it was recorded. It is thus possible to prioritize certain partial regions of the detection region with regard to a desire to enter or to give them lower priority. When using the door system, it is often the case that moving objects in certain regions of the door system or the door leaf usually also want to pass through the door system or the door leaf. In the same way, there are certain regions in front of the door system or in front of the door leaf in which objects move, but which usually do not want to pass through the door system or the door leaf. With the division into partial regions, it is possible to determine the desire to enter of the object depending on the actual entry behavior based on the partial region in which the object is recorded. For example, it is possible to identify the desire to enter of an object from one partial region at a greater distance from the door system or from the door leaf than at a shorter distance of an object from another partial region such that an asymmetrical processing and/or evaluation of the object data takes place.

As a result, the method according to the disclosure ensures that the door leaf does not open for example each time a person approaches transversely to the door system, but the actuation comfort of the door system should be so high that the desire to enter is also reliably detected as far as possible. In this way, the energy efficiency for operating the door system can be improved and/or the service life of the door drive can be extended.

The sensor unit is preferably configured spatially together with or in the immediate vicinity of the drive unit. Alternatively, the sensor unit can be arranged spatially remote from the drive unit, in particular to provide a better detection range.

According to one possible embodiment of the door system, the sensor unit is integrated into the door drive such that the control unit can give commands to the sensor unit such that system integration takes place physically, for example, by means of a CAN bus connection. More comprehensive data is available to the sensor unit such that the hidden region can be defined there, the sensor unit can thus transmit the raw data, unprocessed or unedited, from the detection element of the sensor unit to the control device, and the processing and evaluation of the recorded object data takes place in the control unit or a computer unit of the door controller. As a result, certain detection regions that should not affect the movement of the door leaf can be hidden. For example, a so-called door travel region or other regions of the environment that should not influence the door movement can be hidden, for example if the door system is configured for people adjacent to a transiting area for industrial trucks, as is often provided in industrial buildings.

According to an advantageous further embodiment of the disclosure, it is provided that the object data is recorded in step a) as two-dimensional data of the object and/or that the object data is processed in step b) as or into two-dimensional data of the object.

The object data can preferably be in the form of raw data, in particular consist of raw data, or can comprise raw data.

Alternatively, it is also possible for three-dimensional raw data to be recorded, but the data can be reduced to two-dimensional raw data, which is determined by means of the sensor unit or by means of the control unit or by means of the computer unit, in particular before the object positions are determined.

In particular, the raw data can thereby be assigned to a specific object by means of a computer unit, the sensor unit or the control unit. This is called clustering. Clustering can thereby be carried out using a method known from the state of the art, for example DB SCAN (density-based spatial clustering). It can thus be ensured that the object positions determined thereafter and/or the object vector calculated thereafter relates to a specific object. In particular, the determined object positions can be assigned to a specific object, in particular provided with an object ID, such that the object vector calculated thereafter also relates to a specific object.

In particular, the first and/or the second object position can be determined from a maximum of 10 to 50, preferably from a maximum of 20 to 40, particularly preferably from 30 raw data items, in particular points lying in one plane. The first and/or the second object position can preferably be determined from raw data, in particular points lying in one plane, which have a lifetime from the time of receipt of a maximum of 200 ms to 600 ms, preferably 300 ms to 500 ms, particularly preferably 400 ms. Older raw data can thereby be deactivated or deleted. This enables efficient data reduction with sufficient security.

This reduces the computing and/or memory requirements for operating the door actuator. Alternatively or cumulatively, the object data can consist of two-dimensional data of the object. Objects, generally people, have a three-dimensional extension, which extends in a vertical direction, often referred to as the Z direction. The two-dimensional data is data that is not spatially based but extends only on a plane, with the plane being defined with two directions, such as an X direction and a Y direction. In this plane defined by these two directions is also located the flatly-extending detection region, in particular lying flat on a floor or parallel to a floor, while the Z direction extends perpendicular to the plane spanned by the X direction and the Y direction, thus forming a vertical direction.

Further advantageously, step b) and/or step c) can be carried out in a computer unit, with the computer unit being designed as part of the sensor unit or as part of the control unit. The object data in step b), in particular before step c), can be assigned to a specific object such that the object data of a first object can be distinguished from the object data of a second object, with this distinction advantageously being able to be carried out using the computer unit and not, as usual, taking place in the sensor unit. The sensor unit therefore particularly advantageously supplies the control unit with raw data, in this regard i.e. data of the lowest processing level, which is in particular the data that the detection element of the sensor unit outputs without this having already been preprocessed in the sensor unit. This puts the control device or the computer unit in a position to evaluate the data in a much more detailed and differentiated manner. In particular, the entire data processing takes place in the control unit or the computer unit, proceeding from the raw data from the sensor detection element up to the actuation of the drive of the door leaf.

The raw data from the sensor detection element can comprise a number of recorded points with a specific position, which an object in the detection region, such as a person, triggers, in particular a point cloud. The points thus represent object positions of the objects. The control unit or the computer unit is fed the data comprising the number of recorded points and the processing and evaluation of this object data takes place by means of clustering, by means of which an object vector is created for the or for each existing object based on plausibility considerations.

The object data can thus be processed into object vectors in step b), in particular before step c), and the object data can be evaluated as object vectors in step c). The object vectors are preferably determined with a position of the object in the detection region in front of the door system, with a movement direction and with a speed of the object. The object vector thus already comprises all the information that is necessary to control the movement of the door leaf.

The points of the object data of the object recorded by sensor are used to determine the object vectors for each object, for example by the object vector being determined from at least two object positions of the object data. This determination of the object vectors from the object data can be carried out in particular by means of the computer unit. The object positions can preferably be determined in step b and/or c. It is conceivable that the object vector is determined from more than two object positions, in particular from three or four object positions.

However, the desire to enter can also already be detected if the person, in the later stage of the approach to the door system, approaches more clearly in their movement direction than at the beginning. The aim here is to predict as early as possible and therefore to detect whether or not a person wishes to pass a door system. Thus, the parameter sets can be stored throughout the operating time of the door system such that the movement behavior of the people can provide information as early as possible as to whether or not the person actually wishes to pass the door system.

The movement of the at least one door leaf, in particular the opening, can be carried out by means of control parameters comprising an opening speed and/or an opening width and/or an opening time and/or a closing time after a hold-open time, with these control parameters following the determination of whether the door is open at all or should be reversed.

According to a further advantageous embodiment of the method according to the disclosure, at least the first partial region and the second partial region are determined and/or adapted by means of an artificial intelligence system, with the artificial intelligence system being connected to the computer unit and/or the sensor unit or being part thereof.

The artificial intelligence system, simplified artificial intelligence, AI for short, can thereby be executed on the computer unit of the control unit or the sensor unit or on a separate computer unit. The separate computer unit is thereby preferably designed and configured for at least a temporary or permanent, in particular wireless, data connection with the control unit and/or the sensor unit of the door system.

Thus, the desire to enter can be determined from the actual, current entry behavior. It is thereby also possible to apply the AI permanently over the service life of the door system. In this way, the partial regions of the detection region can be continuously adapted. Alternatively, the object data is collected and transferred to the AI, after which the newly determined partial regions are made available to the door drive. This can take place, for example, at defined time intervals, in particular in the form of an update. This means that the system is not constantly in operation such that the effort can be reduced. The update can take place far away from the door drive using a wireless connection.

According to one embodiment of the present disclosure, it is provided that the artificial intelligence system is trained by means of training data, in particular at least partially in a training phase before step e). It is thereby conceivable that the training phase is carried out completely before step e). However, it is also alternatively conceivable that even during the operation of the door system, for example before, during and/or after step e), training data is used to further train the artificial intelligence system. Therefore, it is also possible to adjust and/or optimize the artificial intelligence system while the door drive is already in operation and/or while the desire to enter is already being determined and/or verified. In particular, the training data can comprise the object data and in particular the object vectors. The training data preferably comprises the event, namely the determination of whether or not the object to which the object data was assigned actually passed the door system or the door leaf.

According to one embodiment of the present disclosure, it is possible that the artificial intelligence system forms a machine learning system or has such a system, or has a deep learning system, a neuronal network and/or pattern detection.

At least the following data is advantageously made available to the artificial intelligence system: Object data, in particular object vectors and/or the event, whether or not the object to which the object data was assigned actually passed the door system and/or environmental conditions, in particular outside temperature and/or inside temperature and/or time and/or break time and/or season and/or place of use of the door system.

It is also conceivable that deactivation data for deactivating the detection of at least one defined region of the detection region is provided to the sensor unit by means of the control device and/or the control device filters out, deletes and/or hides the object data of the sensor unit in a defined region of the detection region.

Particularly advantageously, the sensor unit is formed at least by means of a radar sensor or is provided as a radar sensor.

The method can also comprise the step or the steps, in particular following step e), with the following case distinction: if the door leaf is located in a closed position, the door leaf is moved into an open position only in the case of the identified desire to enter and/or if the door leaf is located in an open position, the movement of the door leaf into the closed position is at least temporarily prevented or the movement into the closed position is reversed and the door leaf is moved into the open position only in the case of the identified desire to enter.

Features and details, which are described in connection with the method according to the disclosure and the door actuator according to the disclosure, also apply in connection with the door system according to the disclosure and vice versa.

The disclosure is also aimed at a door actuator for a door system with at least one door leaf for carrying out the method. In particular, the disclosure is aimed at the use of a door actuator for carrying out a method with the properties described above and/or according to claims 1 to 13 and/or in a door system which has at least one door leaf. Furthermore, the disclosure is aimed at a computer program product for carrying out the method and/or for operating the door actuator.

Features and details, which are described in connection with the method according to the disclosure and the door actuator according to the disclosure as well as the door system according to the disclosure, also apply here in connection with the computer program product according to the disclosure and vice versa.

### BRIEF DESCRIPTION OF THE DRAWINGS

Further measures that improve the disclosure will be outlined in greater detail below together with the description of a preferred exemplary embodiment of the disclosure on the basis of the figures, in which is shown:

FIG. 1 a schematic view of the door system, designed as a swing leaf door, in a top view with two people within a detection region subdivided on two sides in front of the door system,

FIG. 2 the door system in a further top view with a detection region subdivided into multiple sections,

FIG. 3a the door system with a static hidden region and a dynamic hidden region in a second position,

FIG. 3b the door system with a static hidden region and a dynamic hidden region in a second position, FIG. 4 the door system, designed as a sliding door,

FIG. 5 a schematic view of the sequence of the individual method steps characterizing the disclosure, and

FIG. 6 a further exemplary representation.

### DETAILED DESCRIPTION OF THE DRAWINGS

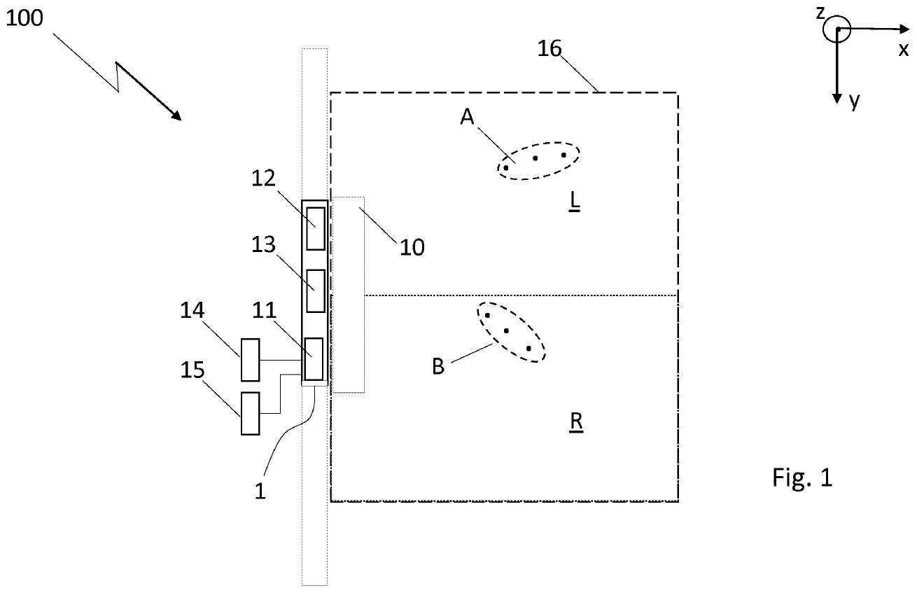

FIG. 1 shows the door system 100 with a door actuator 1 and a movable door leaf 10, designed as a rotary leaf, which is operatively connected to the door actuator 1 and can be pivoted with the same. The door system 100 also has a sensor unit 13, which is connected to a control device 11, with the control device 11 for example being part of the door actuator 1 or being designed so as to form a structural unit with the same.

The sensor unit 13 spans a detection region 16 in front of the door system 100 and, according to the disclosure, said detection region has a first partial region R and a second partial region L and is thus subdivided into two partial regions R and L. The partial regions R and L are spanned symmetrically in front of the door system 100 such that the detection region 16 is subdivided bilaterally symmetrically into the left and into a right partial region L and R directly in front of the door system 100. The region in front of the door system 100 can be an approach region, and, in the sense of the present disclosure, the region in front of the door system can also be an opposing region, which forms an exit area, for example.

Within the detection region 16, two objects A and B are shown, which can represent people by way of example.

Using the sensor unit 13, data of the object A and B is recorded, in particular that are located within the detection region 16. The recorded object data is supplied by the sensor unit 13 as raw data to the control device 11 such that the recorded object data is then processed in the control device 11 and the processed object data is subsequently evaluated. This is followed by either a statically or dynamically adapted subdivision of the detection region 16 into the first partial region R and into the second partial region L. Lastly, it is then identified whether or not a desire to enter of the object A or B depending on the partial region R or L in which the object is located A or B is present.

The object data, which is determined in the first step of recording the object data of the object A, B, is available as two-dimensional object data in an X-Y plane such that the object data has a reduced data volume. The Z direction extending perpendicular to the drawing plane is not taken into account since two-dimensional data from the plane spanned from the two directions X and Y, which are perpendicular to one another, is sufficient to carry out the method.

The division of the detection region into the right partial region R and into the left partial region L is preferably laterally symmetrical, with it also being conceivable, in deviation from the symmetry, that a larger and a smaller partial region R and L is determined. According to the disclosure, the identification of the desire to enter of object A in the left partial region L occurs, for example, under different criteria or under different conditions than the identification of the desire to enter of object B in the right partial region R.

The object data of object A, B are based on points P1, P2 recorded by sensor using the sensor unit 13, with which object vectors are determined and with the object vectors for each object A, B being determined from two object positions P1, P2 of the object data, in particular with the determination of the object vectors from the object data being executed by means of a computer unit 14, with the computer unit 14 being designed as part of the sensor unit 13 or as part of the control unit 11, or, as shown, it is also possible for the computer unit 14 to form an independent unit which is connected to the control unit 11.

For example, there are more points than points P1 and P2, and the raw data of the sensor unit 13, which is supplied to control device 11, can even have point clouds, which are processed by the control device 11 using a cluster method, in particular in step b) or c) of the method, with it being sufficient to determine an object vector of the object A, B from only two object positions P1 and P2. As a result, the method becomes efficient, requires less processor capacity and can be accelerated with regard to the process times.

Furthermore, an artificial intelligence system 15 is shown as an example, with which at least the first partial region R and the second partial region L are determined and/or adapted, with the artificial intelligence system 15 being connected to the computer unit 14 and/or to the sensor unit 13 or being part thereof, with the artificial intelligence system 15 being shown separately for the purpose of graphical representation and in operative connection with the control device 11.

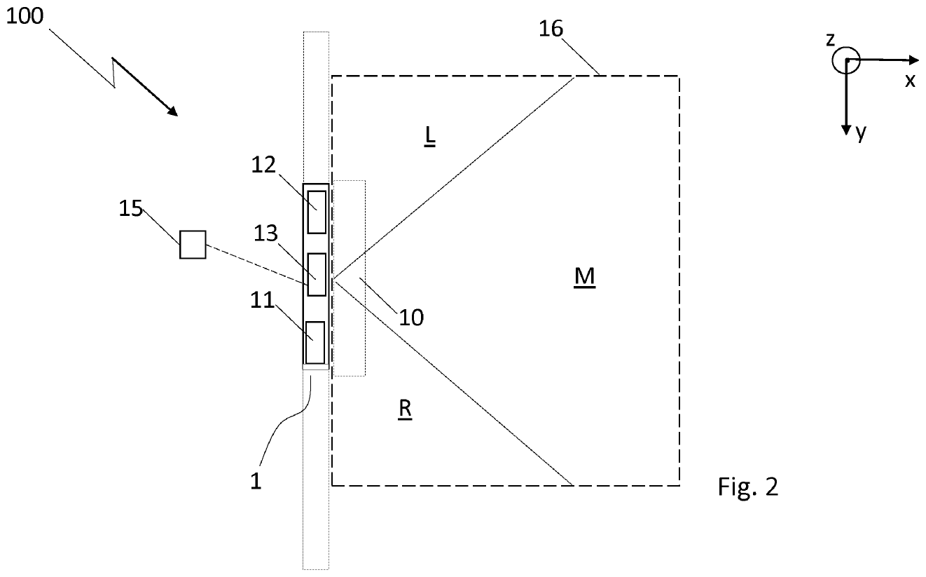

FIG. 2 shows the door system 100 with a door actuator 1 and a movable door leaf 10, also designed as a rotary leaf, which is operatively connected to the door actuator 1 and can be pivoted with the same. The door system 100 also has a sensor unit 13, which is connected to a control device 11, with the control device 11 for example being part of the door actuator 1 or being designed so as to form a structural unit with the same. Furthermore, the artificial intelligence system 15 is shown connected to the control device 11, in which the computer unit 14 is also integrated, for example.

The sensor unit 13 spans a detection region 16 in front of door system 100 and, in contrast to FIG. 1, it has a first right partial region R, a second left partial region L and a central partial region M and is thus subdivided into three partial regions R, L and M. The partial regions R and L are spanned symmetrically in front of the door system 100 and enclose the central partial region M. In this respect, the method according to the disclosure can also be carried out with more than two (2) partial regions of the detection region.

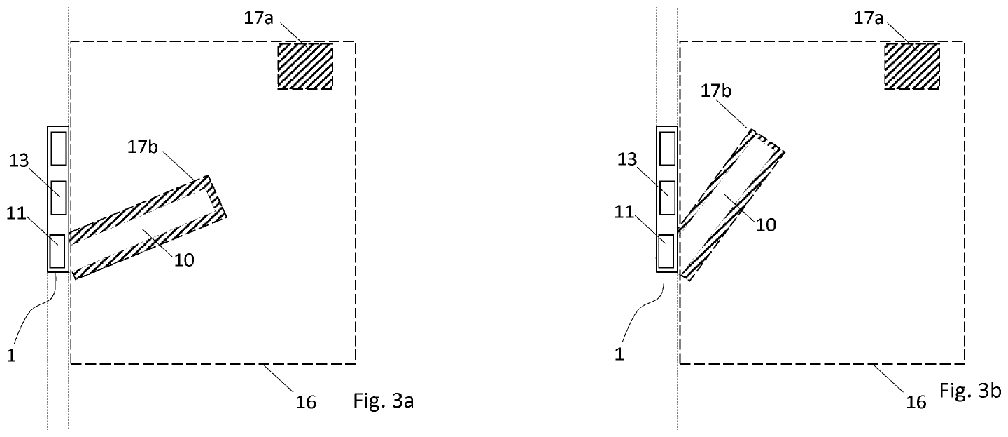

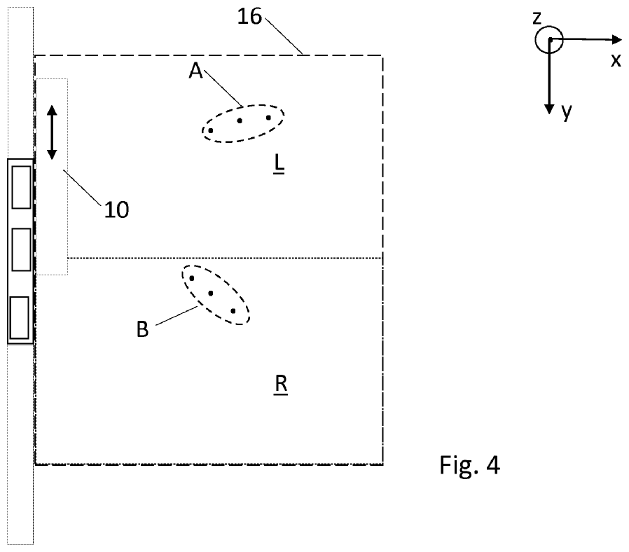

FIGS. 3a and 3b show further schematic views of the door system 100 with the door actuator 1 for operating the door leaf 10, which is designed as an example as a rotary leaf. Hidden regions 17a 17b are created by means of the sensor unit 13 in operative connection with control unit 11, with the hidden region 17a being determined statically within detection region 16 and the hidden region 17b being determined dynamically and moving along with door leaf 10.

This avoids self-detection of the door leaf 10 by the sensor unit 13, with the hidden region 17b whose position changes dynamically within detection region 16 being continuously determined by the control device 11 or the computer unit 14 and, for example, in operative connection with the artificial intelligence system 15. The dynamically changing position of the hidden region 17b as the border of the door leaf 10 becomes clear when comparing the positions of the door leaf 10 and thus also the position of the hidden region 17b between FIGS. 3a and 3b, with the position of the static hidden region 17a not changing.

FIG. 4 shows the door system 100 with a door leaf 10, with the door system 100 being designed as a sliding door system, with the additional features, as already described in connection with FIG. 1, also being used for the sliding door system. The method according to the disclosure can also be used in door systems 100 that are not designed as swing leaf doors but have door leaves 10 that perform a linear movement in front of the detection region 16 to open and close the door system 100. The additional features and associated advantages of the door system 100, which are described in connection with FIG. 1, are also used for a door system 100 designed as a sliding door system according to the illustration.

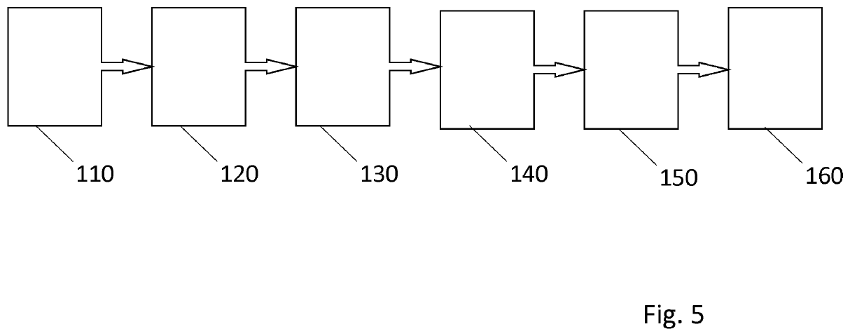

FIG. 5 shows the method steps a) to f), which are carried out in succession as follows: Recording 110 object data of the object A, B, in particular of an object A, B approaching the door system 100, processing 120 the recorded object data, evaluating 130 the processed object data, subdividing 140 the detection region 16 into a first partial region R and into a second partial region L, identifying 150 a desire to enter of the object A, B depending on the partial region R, L in which the object data was recorded and opening 160 the door leaf 10 only in the case of the identified desire to enter.

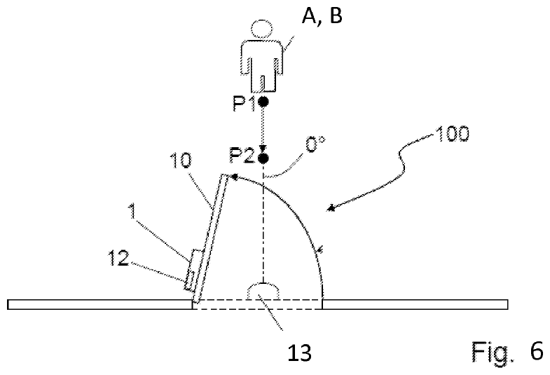

FIG. 6 shows a further exemplary representation. Object positions P1 and P2 are thereby visible.

The design of the disclosure is not restricted to the preferred exemplary embodiment indicated above. In fact, a number of variants is conceivable which make use of the represented solution even in the case of fundamentally different designs. All features and/or advantages emerging from the claims, the description or the drawings, including constructive details or spatial arrangements, may be essential to the disclosure even in the most varied combinations.

1. A method for operating a door actuator of a door system, with at least one movable door leaf and with a control device configured to control a drive of the door leaf, and with a sensor unit with which data of at least one object is recorded in a detection region in front of the door system and at least one item of information about the object is transmitted to the control device, the method including at least the following steps, in the order listed:
a) recording object data of the object,
b) processing the recorded object data,
c) evaluating the processed object data,
d) subdividing the detection region into a first partial region and into at least one second partial region,
e) identifying a desire to enter of the object depending on the partial region in which the object data was recorded, and
f) opening the door leaf only in the case of an identified desire to enter.

2. The method according to claim 1,
wherein the object data is recorded in step a) as two-dimensional data of the object and/or in that the object data in step b) is processed as or into two-dimensional data the object.

3. The method according to claim 1,
whereby step b) and/or step c) are carried out in a computer unit, wherein the computer unit is designed as part of the sensor unit or as part of the control unit.

4. The method according to claim 1,
wherein the object data is assigned to a specific object in step b), before step c), such that the object data of a first object is distinguished from the object data of a second object.

5. The method according to claim 1,
wherein the object data is processed into object vectors in step b), before step c), and the object data is evaluated as object vectors in step c).

6. The method according to claim 5,
wherein the object vectors are determined with a position of the object in the detection region in front of the door system, with a movement direction and with a speed of the object.

7. The method according to claim 1,
wherein the object data of the object has points recorded by sensor, wherein object vectors are determined for each object from two object positions of the object data, wherein the determination of the object vectors from the object data is carried out by the computer unit.

8. The method according to claim 1,
wherein the movement of the at least one door leaf, is carried out by control parameters comprising an opening speed and/or an opening width and/or an opening time and/or a closing time after a hold-open time.

9. The method according to claim 1,
wherein at least the first partial region and the second partial region are determined and/or adapted by an artificial intelligence system, wherein the artificial intelligence system is connected to the computer unit and/or to the sensor unit or is part thereof.

10. The method according to claim 9,
wherein the artificial intelligence system is provided with at least the following data:
object data, and/or
event as to whether the object to which the object data was assigned actually passed through the door system and/or
environmental conditions, including outside temperature and/or inside temperature and/or time and/or break time and/or season and/or place of use of the door system.

11. The method according to claim 1,
wherein deactivation data for deactivating the detection of at least one defined region of the detection region is provided to the sensor unit by the control device and/or the control device filters out, deletes the object data of the sensor unit in a defined region of the detection region and/or hides a hidden region.

12. The method according to claim 1,
wherein the sensor unit is provided comprising at least one radar sensor or as a radar sensor.

13. The method according to claim 1, further including the step or steps, following step e):
if the door leaf is located in a closed position: moving the door leaf into an open position only in the case of the identified desire to enter, and/or
if the door leaf is located in an open position: at least temporarily preventing the movement of the door leaf into the closed position or reversing the movement into the closed position and moving the door leaf into the open position only in the case of the identified desire to enter.

14. A door actuator for a door system which has at least one door leaf, for carrying out a method according to claim 13.

15. A computer program product for carrying out a method according to claim 13 and/or for implementation in the control device and/or the computer unit and/or the sensor unit of a door actuator for a door system which has at least one door leaf.
